(19) United States
(12) Patent Application Publication
(10) Pub. No.: US 2011/0036511 A1
(43) Pub. Date: Feb. 17, 2011

(54) Roller Blind Having a Solar-Driven Electric Motor

(76) Inventor: Sascha Dempwolffe, Odenthal-Blecher (DE)

Correspondence Address: Brinks Hofer Gilson & Lione/Ann Arbor, 524 South Main Street, Suite 200, Ann Arbor, MI, 48104, US

(21) Appl. No.: 12/989,923

(22) PCT Filed: Apr. 6, 2009
(86) PCT No.: PCT/EP2009/054073

§ 371 Date: Oct. 27, 2010

(30) Foreign Application Priority Data
Apr. 29, 2008 (DE) 20 2008 005 928.3

(51) Int. Cl. E06B 9/68; A47H 5/02

(52) U.S. Cl. 160/84.02; 160/310

(57) ABSTRACT

A window blind, in particular a Roman blind, having a blind panel (2) and at least one blind ribbon (4) fastened to one side of the blind panel (2) and having a traction mechanism (8) connected thereto, and a winding device (11) disposed at one end of the blind panel (2) having an electromotive drive (13) that is connected to a rechargeable battery (14), and the battery (14) is electrically charged by means of at least one photovoltaic solar cell (15). The solar cell is attached to the blind panel (2), wherein the electric connection between the battery (14) and the solar cell (15) is formed by electric conductors (6a, 6b) that are attached to the blind ribbon (4) and/or the traction mechanism (8). The electrical conductors can be integrated into the blind ribbon and/or a cord which is part of the winding device (11).

### CROSS REFERENCE TO RELATED APPLICATIONS

This application claims priority to German patent application number 20 2008 005 928.3, filed Apr. 29, 2008, and PCT/EP2009/054073, filed Apr. 6, 2009.

### FIELD OF THE INVENTION

The present invention relates to a window blind, particularly a Roman blind, comprising a blind panel and at least one blind ribbon fastened to one side of the blind panel, a traction mechanism connected thereto, and a winding device disposed at one end of the blind panel.

### BACKGROUND OF THE INVENTION

Window blinds of the above mentioned type are mounted in window cut-outs or window openings and are used to cover the window opening. In this connection, provision for electric motor actuation is desirable. This electric motor actuation requires a connection to an electric grid power supply in the immediate vicinity of the winding device, which significantly increases the mounting costs. In addition, later attachment is only possible in instances where an electrical connection is available near the mounting location.

The present invention is based on the object of enabling a supply of electric power for electric motor-driven window blinds that is independent of the power grid.

### SUMMARY OF THE INVENTION

According to the invention, this object is achieved by the winding device having an electromotive drive that is connected to a rechargeable battery, and the battery being electrically charged by means of at least one photovoltaic solar cell fastened to the blind panel, whereby the electric connection between the battery and the solar cell is formed by electric conductors that are installed on or in the blind panel and/or on or in the traction mechanism.

The photovoltaic solar cell is advantageously fastened to the end of the blind panel opposite of the winding device, and the blind ribbon is advantageously made of a woven fabric ribbon, wherein the electric line is formed by an electrically conductive yarn that is integrated into the woven fabric structure. In this connection, it is particularly advantageous if the electric line is composed of warp threads made of electrically conductive yarns that are woven into the longitudinal edges of the woven fabric ribbon.

Additional advantageous embodiments are described herein.

### BRIEF DESCRIPTION OF THE DRAWINGS

The invention is explained in more detail based on the exemplary embodiment shown in the attached drawings. In the drawings:

FIG. 1 is a view of a Roman blind according to the invention, and

FIG. 2 is a view of a blind ribbon used according to the invention.

### DETAILED DESCRIPTION OF THE INVENTION

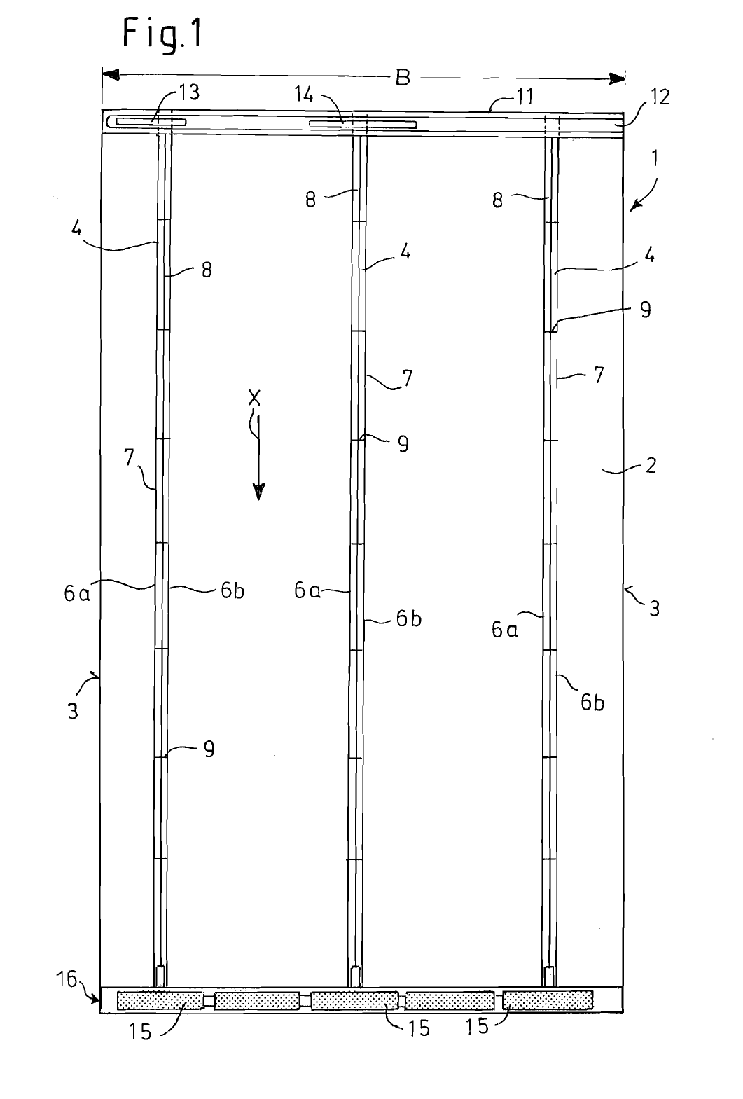

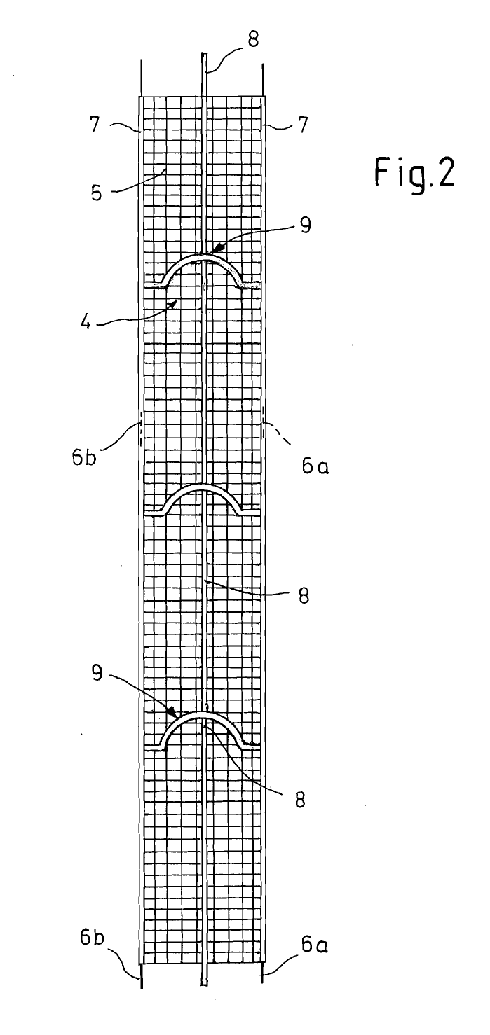

FIG. 1 illustrates a window blind 1 according to the invention. This is a Roman blind. The Roman blind comprises a blind panel 2, which, for example, is made of a textile and/or synthetic material. However, it is also possible within the scope of the invention to design it as a roller blind according to the invention instead of a Roman blind. According to FIG. 1, in the exemplary embodiment shown, a plurality, in particular three blind ribbons 4, are sewn onto the blind panel 2 in the longitudinal direction X of the blind panel and parallel to the longitudinal edges 3 thereof. These blind ribbons 4 are preferably made of a woven fabric ribbon 5, as shown in FIG. 2. At least one of the blind ribbons 4, and preferably all of the sewed-on blind ribbons 4, comprise one or two electric conductors 6a, 6b. As is shown in FIG. 2, the electric conductors 6a, 6b are preferably composed of two electrically conductive yarns of the known type that are woven into the fabric, wherein the conductive yarns form warp threads of the woven fabric ribbon 5, said warp threads being woven into the longitudinal edges 7 of the woven fabric ribbon 5. Furthermore, each of the blind ribbons 4 has a traction mechanism 8 that is guided by loops 9 or other guiding means that are attached to the woven fabric ribbon 5, for example guide eyes or the like. This traction mechanism 8 is advantageously a draw cord made of a textile material. A winding device 11 is attached at one end of the blind panel 2 and extends over the entire width B of the blind panel 2. The winding device 11 is designed in the known Roman blind winding technology and has a hollow shaft 12. The traction mechanism 8 is connected to one end of this hollow shaft 12, so that by means of a rotational movement of the hollow shaft 12 in one direction, the traction mechanism 8 can be wound onto the hollow shaft 12, or onto the reels located on the hollow shaft. In so doing, the end of the blind panel opposite of the winding device 11, to which the traction mechanism 8 is connected, is drawn in the direction of the winding device 11. In the mounted, hanging state of the Roman blind, the lower end of the Roman blind is therefore draw upward in the direction of the winding device 11, the blind panel 2 thereby forming folds. At the end of the blind panel 2 opposite of the winding device 11, which is the lower end, the blind panel 2 has a valance-like finish 16, into which a stiffening insert is advantageously introduced. By rotationally moving the hollow shaft 12 in the opposite direction of the winding direction, the traction mechanism or mechanisms 8 can unwind and move the blind panel 2 downward. The force necessary to do this is produced by the dead weight of the blind panel 2, which is why it is advantageous to increase the weight of the blind panel 2 by means of the stiffening insert, particularly at the lower end, thereby ensuring uniform application of force.

According to the invention, electromotive actuation of the window blind 1 is provided for. For this purpose, an electric motor 13 of a known type is advantageously arranged in the hollow shaft 12, and the rotor of the electric motor 13 is connected to the hollow shaft 12. The electric motor 13 is preferably a low-voltage, direct-current motor and is supplied with direct current of 24 volts, which is produced by a rechargeable battery 14, which is electrically connected to the electric motor 13. According to the invention, the battery 14 is charged by means of one or more photovoltaic solar cells 15, thus achieving a supply of electricity and installation of the window blind 1 according to the invention independent of the power grid. According to the invention, the solar cells 15 are advantageously attached to the lower end of the blind panel 2, and more specifically on the side that faces the outside in a mounted state, so that the solar cells 15 are not covered and are exposed to daylight in both the lowered state of the window blind and in its drawn-up state. The electric connection of the solar cells 15, which are preferably connected in series, to the battery 14 is established by the electric conductors 6a, 6b present in the blind ribbons 4. For this purpose, it is also advantageous if the blind ribbons 4 as well as the solar cells 15 are attached to the outer side of the blind panel 2. Instead of an electric supply via the blind ribbons 4, it can also be advantageous according to the invention to design the traction mechanism 8 that is connected to the blind ribbon 4 to be electrically conductive, by having an electric conductor made of an electrically conductive yarn, for example, integrated in the traction mechanism 8. The traction mechanism itself can, for example, be composed of a cord made of textile material. In this case, the traction mechanisms are electrically connected at one end to the solar cell or solar cells 15, and at the other end, there is an electric connection to the battery 14. In order to achieve the best possible optical impression for the window blind 1 according to the invention, it is advantageous if the woven fabric ribbons 5 of the blind ribbons 4 are made of a transparent material. The conductive yarns used to produce the electric conductors 6a, 6b, could, for example, be yarns that have an external silver coating. The solar cells 15 are preferably attached to the lower end of the blind panel 2 by means of a Velcro closure, so as to enable easy installation and removal.

While the above description constitutes the preferred embodiment of the present invention, it will be appreciated that the invention is susceptible to modification, variation, and change without departing from the proper scope and fair meaning of the accompanying claims.

1. A window blind, in particular a Roman blind, comprising a blind panel (2) and at least one blind ribbon (4) fastened to one side of the blind panel (2) and having a traction mechanism (8) connected thereto, and a winding device (11) disposed at one end of the blind panel (2) having an electromotive drive (13) that is connected to a rechargeable battery (14), and the battery (14) is electrically charged by means of at least one photovoltaic solar cell (15) that is attached to the blind panel (2), wherein the electric connection between the battery (14) and the solar cell (15) is formed by electric conductors (6a, 6b) that are attached to or part of at least one of the blind ribbon (4) and the traction mechanism (8).

2. The window blind according to claim 1, further comprising in that at the one end of the blind panel (2) opposite of the winding device (11), a valence-like finish (10) is configured, which is stiffened by means of an insert, and the solar cell (15) is attached to the finish (10).

3. The window blind according to claim 1, further comprising in that the solar cell (15) is detachably fastened to the blind panel (2) by means of a Velcro closure (2).

4. The window blind according to claim 1, further comprising in that the blind panel (2) is made of a textile or a synthetic material.

5. The window blind according to claim 1, further comprising in that a plurality of the solar cells (15) are used which are connected in series.

6. The window blind according to claim 1 further comprising in that the winding device (11) comprises a hollow shaft (12), in which an electric driving motor (13) forming the electromagnetic drive is disposed.

7. The window blind according to claim 1, further comprising in that the battery (14) is disposed inside the hollow shaft (12).

8. The window blind according to claim 1, further comprising in that the blind ribbon (4) is made of a textile material.

9. The window blind according to claim 1, further comprising in that the blind ribbon (4) and the solar cell (15) are disposed on the one side facing the outside in the mounted state of the window blind (1).

10. The window blind of a type according to claim 1, further comprising in that the blind ribbon (4) is made of a woven fabric ribbon (5) and comprises at least one of the electric conductor (6a, 6b).

11. The window blind according to claim 10, further comprising in that the electric conductor (6a, 6b) is made of an electrically conductive yarn and is woven into the blind ribbon (4).

12. The window blind according to claim 11, further comprising in that two electric conductors (6a, 6b) are present, which are each woven into the longitudinal edges (7) of the woven fabric ribbon (5) as warp threads.

13. The window blind ribbon according to claim 10, further comprising in that the woven fabric ribbon (5) is made of a transparent material.

14. The window blind according to claim 10, further comprising in that the traction mechanism (8) that is connected to the woven fabric ribbon (5) comprising the electric conductor.

15. The window blind according to claim 14, further comprising in that the traction mechanism (8) comprises a cord made of a textile material, and the electric conductor is formed by an electrically conductive cord yarn.

16. (canceled)

17. A blind ribbon for a window blind, of a type having a blind panel (2) and at least one of the blind ribbon (4) fastened to one side of the blind panel (2) and having a traction mechanism (8) connected thereto, and a winding device (11) disposed at one end of the blind panel (2) having an electromotive drive (13) that is connected to a rechargeable battery (14), and the battery (14) is electrically charged by means of at least one photovoltaic solar cell (15) that is attached to the blind panel (2), wherein the electric connection between the battery (14) and the solar cell (15) is formed by electric conductors (6a, 6b), comprising the blind ribbon (4) is made of a woven fabric ribbon (5) and comprises the electric conductors (6a, 6b).

18. A blind ribbon for a window blind according to claim 17 further comprising, in that the electric conductors (6a, 6b) are made of an electrically conductive yarn and is woven into the blind ribbon (4).

19. A blind ribbon for a window blind according to claim 17 further comprising, in that two of the electric conductors (6a, 6b) are present, which are each woven into the longitudinal edges (7) of the woven fabric ribbon (5) as warp threads.

20. A blind ribbon for a window blind according to claim 17 further comprising, in that the woven fabric ribbon (5) is made of a transparent material.

21. A blind ribbon for a window blind according to claim 17 further comprising, in that the traction mechanism (8) that is connected to the woven fabric ribbon (5) comprises the electric conductors.

22. A traction mechanism cord for a window blind, of a type having a blind panel (2) and at least one of the blind ribbon (4) fastened to one side of the blind panel (2) and having a traction mechanism (8) connected thereto, and a winding device (11) disposed at one end of the blind panel (2) having an electromotive drive (13) that is connected to a rechargeable battery (14), and the battery (14) is electrically charged by means of at least one photovoltaic solar cell (15) that is attached to the blind panel (2), wherein the electric connection between the battery (14) and the solar cell (15) is formed by electric conductors (6a, 6b), comprising the blind ribbon (4) is made of a woven fabric ribbon (5) and comprises the cord made of a textile material, and the electric conductor are formed by an electrically conductive yarn forming the cord.
